(19) United States
(12) Patent Application Publication
(10) Pub. No.: US 2013/0201525 A1
(43) Pub. Date: Aug. 8, 2013

(54) WIRELESS COMMUNICATION DEVICE

(71) Applicant: SEIKO EPSON CORPORATION, Tokyo (JP)

(72) Inventor: Takamasa NIWA, Hachioji, Tokyo (JP)

(73) Assignee: SEIKO EPSON CORPORATION, Tokyo (JP)

(21) Appl. No.: 13/760,601

(22) Filed: Feb. 6, 2013

(30) Foreign Application Priority Data
Feb. 7, 2012 (JP) 2012-023852

(51) Int. Cl. G06F 3/12

(52) U.S. Cl. CPC G06F 3/1236
USPC 358/1.15

(57) ABSTRACT

To provide a wireless communication device that performs a wireless communication with a desired wireless communication device without any control to select a destination device by a user, a wireless communication device includes a communication unit that performs a peer-to-peer wireless communication with other wireless communication devices, and a communication control unit that controls a wireless communication in accordance with a communication setting information. When the communication unit sends a search signal and receives a response signal for the sent search signal from a plurality of the other wireless communication devices, the communication control unit makes a determination of the order for a connection request to the plurality of the other wireless communication devices in the order of a strength of the response signals from the largest to the smallest. The communication unit sends a connection request signal to the other wireless communication devices in accordance with the decided order.

### CROSS-REFERENCE TO RELATED APPLICATIONS

This application claims priority to Japanese Patent Application No. 2012-023852 filed on Feb. 7, 2012. The entire disclosure of Japanese Patent Application No. 2012-023852 is hereby incorporated herein by reference.

### BACKGROUND

1. Technical Field

The present invention relates to a wireless communication device.

2. Background Technology

As a method for establishing a network, there is a method for performing Wi-Fi Direct (hereinafter referred to as “Wi-Fi Direct Connection”) under Wi-Fi Alliance standard development. A wireless communication device that is possible to perform the Wi-Fi Direct Connection can directly communicate with other wireless communication devices that are also possible to perform the Wi-Fi Direct Connection as one-on-one communication or a multiple devices communication without using an access point. Also, it is possible to communicate with a wireless communication device that is possible to perform a wireless LAN connection method used with Wi-Fi (hereinafter referred to as “Wi-Fi Connection”) function as an access point. In addition, since the Wi-Fi Direct Connection uses the Wi-Fi technologies, the high-speed communication is possible.

Normally, in the wireless communication device that is possible to perform the Wi-Fi Direct Connection, when the Wi-Fi Direct Communication is validated by a user, a device list that lists wireless communication devices that are possible to perform the Wi-Fi Direct Connection Communication is displayed in the equipped display. And, the user controls to select a device for a Wi-Fi Direct Connection communicate from the device list displayed in the equipped display so that it starts the Wi-Fi Direct Connection communication with the desired wireless communication device.

Also, when the user uses the Wi-Fi Direct Connection communication, the wireless communication devices are often used to close to one another in order to be within a communication range of the wireless devices from each other to perform the Wi-Fi Direct communication. For example, when an image in a cellular phone is printed out, the user carries the cellular phone to be closer to a printer within a communication range and the image is directly sent to the printer from the cellular phone by the Wi-Fi Direct Connection communication so as to print out the image.

Japanese Laid-open Patent Publication No. 2011-166417 (Patent Document 1) and http://205.149.128.22/Wi-Fi_Direct.php (Non-patent Document 1) are examples of the related art.

### SUMMARY

### Problems to Be Solved by the Invention

In a wireless communication device such as a printer, there is a device which is not equipped with a display because of the limitations such as a specification limitation and costs limitation, or there is a device which is equipped with a display in a small size so as to display only short massages. In these wireless communication devices, the device list cannot be displayed so that the user cannot select a desired wireless communication device by controlling these wireless communication devices and the Wi-Fi Direct Connection communication cannot be performed with the desired wireless communication device.

Therefore, the advantage of the invention is to provide a wireless communication device to perform the Wi-Fi Direct Connection communication with a desired wireless communication device without any control to select a destination device by a user.

### Means Used to Solve the Above-Mentioned Problems

The first aspect of a wireless communication device is to perform a wireless communication with other wireless communication devices. The wireless communication device includes a communication unit to perform a peer-to-peer wireless communication with the above described other wireless communication devices, and it includes a communication control unit to control the peer-to-peer wireless communication of the communication unit in accordance with a communication setting information. When the communication unit sends a search signal and response signals in response to the sent search signal are received from a plurality of the above described other wireless communication devices, the communication control unit makes a determination for an order of connection requests to connect with the above described other wireless communication devices based on a strength of the response signals. The communication unit sends a connection request signal to the above described other wireless communication devices in accordance with the determined order. When the connection permission signal in response to the connection request signal is received, the communication control unit establishes the peer-to-peer wireless communication connection with the above described other wireless communication devices that the connection permission signals were sent.

The first aspect of the wireless communication device can establish a Wi-Fi Direct Connection network with a desired wireless communication device without any control to select a destination device by a user.

### BRIEF DESCRIPTION OF THE DRAWINGS

Referring now to the attached drawings which form a part of this original disclosure:

FIG. 1 shows a wireless communication system according to the present embodiment;

FIG. 2 is a flowchart of a network establishing process according to the present embodiment; and

FIG. 3 is a sequence diagram of a network establishing process according to the present embodiment.

### DETAILED DESCRIPTION OF EXEMPLARY EMBODIMENTS

Hereinafter, the embodiments of the invention will be explained with reference to the drawings.

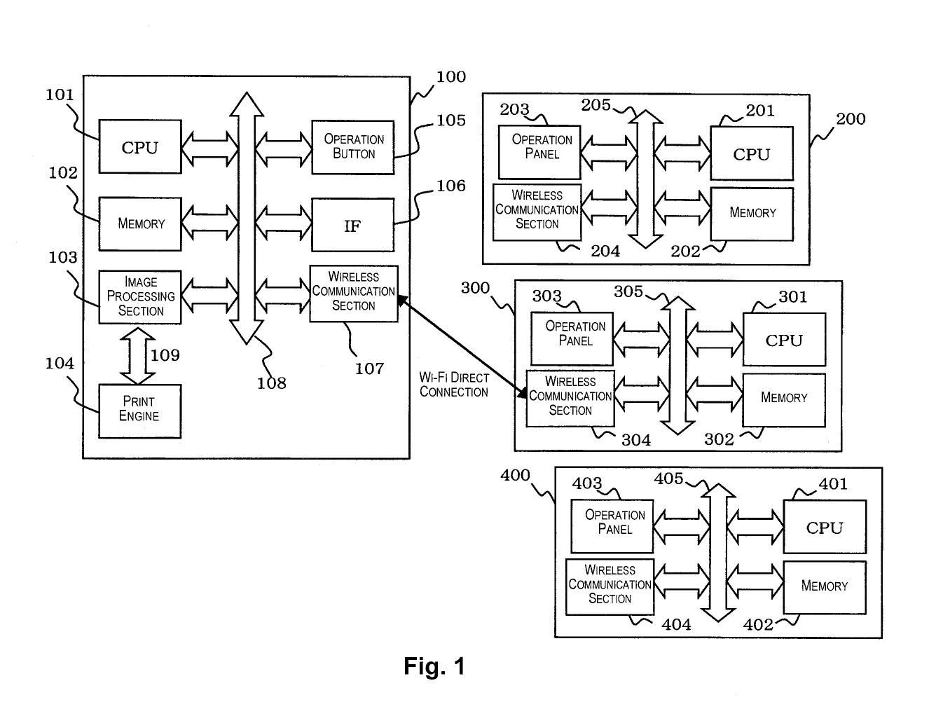

FIG. 1 shows a wireless communication system according to the present embodiment. The present system includes a printer 100 and mobile terminals 200 to 400. The mobile terminals are arranged in a vicinity of the printer 100 in the order of the mobile terminals 200, 300, and 400.

It is possible to perform a peer-to-peer wireless communication by the Wi-Fi Direct Connection between the printer 100 and the mobile terminals 200 to 400. Also, when the Wi-Fi Direct Connection communication is not performed between the printer 100 and the mobile terminals 200 to 400, the Wi-Fi Direct Connection is invalidated. However, when the Wi-Fi Direct Connection is validated by a predetermined control as described later, a peer-to-peer network by the Wi-Fi Direct Connection is established with another wireless communication device which validates the Wi-Fi Direct Connection. And, when the Wi-Fi Direct Connection becomes invalidated by a predetermined control as described later, the Wi-Fi Direct Connection network is turned off.

In the present embodiment, the mobile terminals 200 to 400 preliminary validate the Wi-Fi Direct Connection, but the printer 100 invalidates the Wi-Fi Direct Connection. Thus, the Wi-Fi Direct Connection network is not established between the printer 100 and the mobile terminals 200 to 400. Although in the present embodiment, the Wi-Fi Direct Connection is validated in the mobile terminals 200 to 400, the Wi-Fi Direct Connection network is not established between the mobile terminals 200 to 400.

First of all, when a user controls the printer 100 to validate the Wi-Fi Direct Connection, a network establishing process as described later is performed so that the Wi-Fi Direct Connection network is established between the printer 100 and any one of the mobile terminals 200 to 400.

In the network establishing process, the printer 100 sends a probe request (search signal) and searches a Wi-Fi Direct Connection validated wireless communication device such as the mobile terminals 200 to 400 in a communication range of the printer 100. After the end of the search, the printer 100 sends a connection request to the wireless communication devices in the order of the strengths of the probe responses from largest to smallest in response to the probe request for the searched wireless communication devices. That is, the printer 100 sends a connection request in the order of the wireless communication devices from closest to farthest to the printer 100. When a desired wireless communication device received a connection request from the printer 100, the user controls the wireless communication device to send a connection permission to the printer 100 so that the Wi-Fi Direct Connection network is established between the desired wireless communication device and the printer 100.

Because of this, the user only controls the printer 100 to validate the Wi-Fi Direct Connection and then, the Wi-Fi Direct Connection network can be established without any control to select a desired wireless communication device from a device list. Therefore, the Wi-Fi Direct Connection network can be established with the user's desired wireless communication device without displaying the device list in the printer 100 for the user.

### Printer 100

The printer 100 includes a CUP 101, a non-volatile memory 102, an image processing section 103, a print engine 104, an operation button 105, an interface 106, a wireless communication section 107 (communication unit), and buses 108, 109.

The CPU 101 executes various programs such as a print control program stored in the non-volatile memory 102 and a communication control program to perform a network establishing process as described later so that it controls the respective parts in the printer 100. That is, the control unit is constituted by the CPU 101 and the communication control program. Other than the various programs, the non-volatile memory 102 stores data such as communication setting information to perform the Wi-Fi Direct Connection communication.

The communication setting information is the temporary information such that the communication setting information is stored in the non-volatile memory 102 every time the Wi-Fi Direct Connection network is established, and it is deleted in the non-volatile memory 102 every time the Wi-Fi Direct Connection network is turned off. That is, although the printer 100 validates the Wi-Fi Direct Connection, when the Wi-Fi Direct Connection network is not established, the non-volatile memory 102 does not store the communication setting information. Also, this communication setting information includes the Service Set Identifier (SSID), and a new SSID is produced by the CPU 101 every time the Wi-Fi Direct Connection network is established.

By the way, the communication setting information is the temporary data to perform the Wi-Fi Direct Connection communication so that it can be stored in a RAM of the printer 100, which is not shown in the drawings, instead of the non-volatile memory 102. In this case, the Wi-Fi Direct Connection communication is performed based on the communication setting information stored in the RAM.

The user can select to validate or invalidate the Wi-Fi Direct Connection by pressing the operation button 105. When the user selects to validate the Wi-Fi Direct Connection by pressing the operation button 105, the network establishing process as described later starts. In addition, when the user selects to invalidate the Wi-Fi Direct Connection by pressing the operation button 105, the established Wi-Fi Direct Connection network is turned off.

The interface 106 is connected to an external device such as a computer, which is not shown in the drawings, by a LAN cable.

The wireless communication section 107 performs a wireless communication with the mobile terminal 200 by the Wi-Fi Direct Connection or it performs a wireless communication with the access point 300 by the Wi-Fi Direct Connection. Also, the wireless communication section 107 includes the Received Signal Strength Indicator (RSSI) circuit so that the strength of a received signal is detected.

The image processing section 103 receives an image data through the interface 106 or the wireless communication section 107 and the image processing is performed to produce a print data. Also, the print engine 104 connecting to the image processing section 104 through the bus 109 prints out an image based on the print data.

### Mobile Terminals 200 to 400

The mobile terminal 200 includes a CPU 201 that executes various programs such as a communication operation program and operates the respective parts in the mobile terminal, a non-volatile memory 202 that stores various programs and data, a operation panel 203 that displays a message and receives an operation from the user, a wireless communication section 204 that performs a communication in one of the Wi-Fi Direct Connection and the Wi-Fi Connection, and a bus 205.

The operation panel 203 displays a Wi-Fi Direct validation button and a Wi-Fi Direct invalidation button. When the Wi-Fi Direct validation button is pressed, it validates the Wi-Fi Direct Connection so that the Wi-Fi Direct Connection network is established with another wireless communication device such as the printer 100 which is possible for the Wi-Fi Direct Connection. Also, when the Wi-Fi Direct invalidation button displayed in the operation panel 203 is pressed, it invalidates the Wi-Fi Direct Connection so that the established Wi-Fi Direct Connection network is turned off.

The mobile terminals 300, 400 include the same structure as the mobile terminal 200. As described above, in the present embodiment, the Wi-Fi Direct validation button has been already pressed in the mobile terminals 200 to 400 so that the Wi-Fi Direct Connection is validated.

### Network Establishing Process

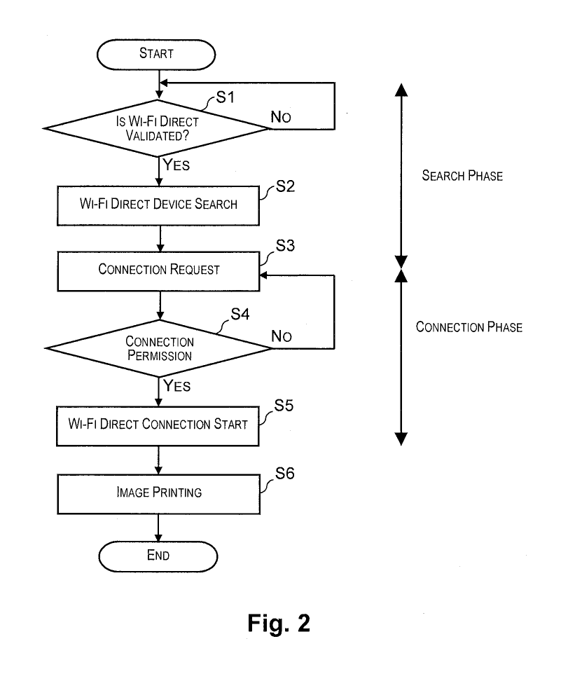

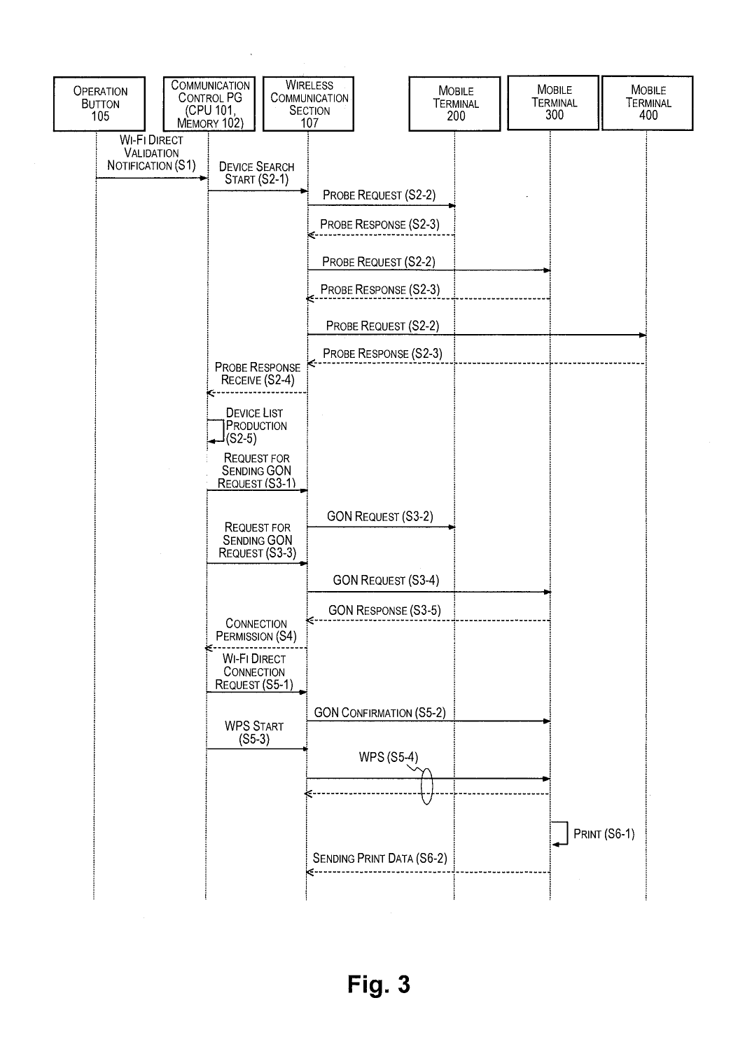

The concrete examples of the network establishing process in the present embodiment are shown in FIGS. 2 and 3. FIG. 2 is a flowchart of the network establishing process in the present embodiment. Also, FIG. 3 is a sequence diagram of a network establishing process according to the present embodiment.

FIG. 2 shows the network establishing process in Steps S1 to S5 and the image printing process (S6) of the printer 100 after establishing the Wi-Fi Direct Connect network. Also, the network establishing process includes Steps S1 to S2 of a search phase and Steps S3 to S5 of a connection phase. The concrete process of each step is shown in FIG. 3.

### Search Phase

When the Wi-Fi Direct Connection has been preliminary validated in the mobile terminals 200 to 400 and the user presses the operation button 105 of the printer 100 to validate the Wi-Fi Direct Connection, the network establishing process starts. Concretely, when the user presses the operation button 105, the CPU 101 is notified that the Wi-Fi Direct Connection was validated (S1) and the CPU 101 executed the process of Step S2.

In Step S2, within the communication range of the wireless communication section 107 in the printer 100, it performs to search wireless communication devices which validate the Wi-Fi Direct Connection (S2). The CPU 101 instructs the wireless communication section 107 to start a device search (S2-1). And, in response to the instruction, the wireless communication part 107 sends a probe request to the wireless communication devices existed in a vicinity of the printer 100 (S2-2). In this time, the probe request includes the device identification information such as a MAC address of the printer 100, a device name, and a device type.

When the wireless communication sections 204, 304, 404, of the mobile terminals 200, 200, 400, which validate the Wi-Fi Direct Connection, receive a probe request sent from the wireless communication section 107 of the printer 100, the wireless communication sections 204, 304, 404, send a probe response to the wireless communication section 107 (S2-3). This probe response includes the device identification information of the mobile terminals 200, 300, 400, such as a MAC address, a device name, and a device type.

And, the CPU 101 receives the respective probe response through the wireless communication section 107 with a strength of the probe response signals of the mobile terminals 200 to 400 which were detected by the wireless communication section 107 (S2-4). In this time, if there is another wireless communication device, which validates the Wi-Fi Direct Connection, other than the mobile terminals 200 to 400, in the same manner, it performs to send a probe request and to receive a probe response for the another wireless communication device.

Next, when the CPU 101 receives the probe responses from the wireless communication devices that validate the Wi-Fi Direct Connection, it produces a device list based on the received probe responses (S2-5). The device list is a list showing the device identification information or the like, which is included in the probe responses, and it lists each wireless communication device that validates the Wi-Fi Direct Connection existed in the communication range of the printer 100. In addition, in the device list, the CPU 101 lists up the wireless communication devices in the order of the strengths of the probe response signals from the largest to the smallest. Normally, as a location of the wireless communication device that validates the Wi-Fi Direct Connection is closer to the printer 100, the strength of the probe response signal from the wireless communication device becomes larger. Therefore, in the present embodiment, the mobile terminals 200 to 400 are listed in the order of the mobile terminals 200, 300, and 400 in the device list.

As described above, in the search phase, when the printer 100 validates the Wi-Fi Direct Connection, it sends a probe request so that it searches wireless communication devices that validate the Wi-Fi Direct Connection in the communication range of the printer 100. And, as the search result, the printer 100 produces a device list in the order of the strengths of the probe response signals from the largest to the smallest.

By the way, if a wireless communication device that validates the Wi-Fi Direct Connection in the communication range of the printer 100 is only one, for example, it is only the mobile terminal 200, the device list only shows the mobile terminal 200.

### Connection Phase

After Step S2, the CPU 101 requests a connection in the order of the strengths of the probe response signals from the largest to the smallest based on the devise list (S3). Concretely, the CPU 101 sends a request of the Group Owner Negotiation (hereinafter referred to as “GON”) which is a connection request to the mobile terminal 200 that has the largest strength of the signal to the wireless communication section 107 (S3-1). And, in response to the request, the wireless communication section 107 sends the GON request to the wireless communication part 204 of the mobile terminal 200 (S3-3).

When the wireless communication section 204 of the mobile terminal 200 receives the GON request, a message for the connection request from the printer 100 is displayed in the operation panel by the CPU 201. However, in the present embodiment, since the mobile terminal 200 does not perform the Wi-Fi Direct Connection communication with the printer 100, the user does not perform any operation to the mobile terminal 200. And, when a predetermined time (for example, 15 seconds) after sending the GON request (S3-2) was elapsed and there was no response from the mobile terminal 200, it is determined that the connection request was refused (S4) so that the CPU 101 performs a connection request to the mobile terminal 300 which has the second largest strength signal (S3-3). And, in response to the request, the wireless communication section 107 sends the GON request to the wireless communication section 304 of the mobile terminal 300 (S3-4).

At this point, in response to the connection request to the mobile terminal 200 from the printer 100 (S3-2), when the user controls the operation panel 203 to refuse the connection with the printer 100, the GON response notifying the connection refusal is sent to the wireless communication section 107 of the printer 100 from the wireless communication section 204 of the mobile terminal 200. And, when the CPU 101 received the GON response of the mobile terminal 200 through the wireless communication section 107 and it notified that the connection request was refused (S4), the CPU 101 preforms the connection request to the mobile terminal 300 which has the second largest strength signal (S3-3). And, in response to the request, the wireless communication section 107 sends the GON request to the wireless communication section 304 of the mobile terminal 300 (S3-4).

When the wireless communication section 304 of the mobile terminal 300 received the GON request, a message that the connection request was received from the printer 100 is displayed in the operation panel 303 by the CPU 301. And, when the user controls the operation panel 303 to permit the connection with the printer 100, the GON response that notifies the connection permission is sent to the wireless communication section 107 of the printer 100 through the wireless communication section 304 of the mobile terminal 300 (S3-5).

When the GON response that notifies the connection permission through the wireless communication section 107 was received (S4), the CPU 101 produces the SSID for the Wi-Fi Direct Connection communication with the mobile terminal 300. The CPU 101 stores the communication setting information such as a produced SSID, a password, an IP address that are necessary for the Wi-Fi Direct Connection in the non-volatile memory 102.

After completing Step S4, the CPU 101 starts the Wi-Fi Direction Connection communication (S5). First, the CPU 101 requests the wireless communication section 107 to send the GON confirmation to notify that the network between the printer 100 and the mobile terminal 200 in a wireless layer level was established (S5-1). And, the wireless communication section 304 receives the GON confirmation sent from the wireless communication section 107 (S5-2).

After that, the CPU 101 starts setting the security information by Wi-Fi Protected Setup (WPS) method, and the WPS is performed between the printer 100 and the mobile terminal 300 so that the Wi-Fi Direct Connection communication becomes possible.

When the user controls the operation panel 303 of the mobile terminal 300 to start a print process of an image (S6-1), the image data of the mobile terminal 300 is sent to the wireless communication section 107 of the printer 100 from the wireless communication section 304 of the mobile terminal 300 (S6-2). The image processing section 103 receives the image data of the mobile terminal 300 through the wireless communication section 107 to produce a print data. And, the print engine 104 prints out the image based on the print data.

By the way, the printer 100 sends a connection request in the order of the strength of the signals from the largest to the smallest as described above, and if the printer 100 did not receive the connection permission from any one of them, the network establishing process is end.

As described above, in the connection phase, the printer 100 performs the connection request in the order of the strength of the signals from the largest to the smallest for the wireless communication devices in the device list produced in the search phase. That is, first, it performs the connection request for the wireless communication device having the largest strength of the signal. And, when the predetermined time was elapsed and the response to the connection request was not received, or when the notification of the connection refusal was received, the printer 100 performs the connection request to the wireless communication device having the next largest strength of the signal. As discussed above, the printer 100 performs the connection request in the order of the strength of the signals from the largest to the smallest until receiving the notification of the connection permission. Then, the printer 100 starts the Wi-Fi Direct Connection communication with the wireless communication device that the printer 100 received the notification of the first connection permission.

Because of this, once the Wi-Fi Direct Connection is validated on the printer 100 side by the user, after that, the Wi-Fi Direct Connection network can be established with the desired wireless communication device without selecting the desired wireless communication device from the device list. That is, the display panel to display the device list becomes unnecessary in the printer 100.

By the way, if the device list shows only one wireless communication device that validates the Wi-Fi Direct Connection, as described above, the wireless communication device receives the connection request from the printer 100. And, when the printer 100 received the notification of the connection permission from the wireless communication device, it starts the Wi-Fi Direct Connection communication with the wireless communication device. On the other hand, when the predetermined time after sending the connection request was elapsed and the response to the connection request was not received, or when the notification of the connection refusal was received, the network establishing process is end.

If there are many wireless communication devices in the vicinity of the printer 100, it can take time to send the connection request to the desired wireless communication device when the desired wireless communication device is away from the printer 100. Thus, in Step S3, the CPU 101 can perform a connection request in the order of the strength of the signals from the largest to the smallest in a predetermined limited number of the devices or a predetermined ratio of the number of the devices. Because of this, although the Wi-Fi Direct Connection was validated on the printer 100 side, if the connection request was not received in the desired wireless communication device, the user can realize that the desired wireless communication device needs to be closer to the printer 100 so that after moving it to closer, the Wi-Fi Direct Connection can be validated by the operation button 105 of the printer 100.

Also, in Step S3, the CPU 101 can perform the connection request in the order of the strength of the signals from the largest to the smallest for the wireless communication devices having the predetermined device identification information based on the device identification information such as a device type having a probe response. For example, if it is for the image printing as described in the present embodiment, the CPU 101 can perform the connection request in the order of the strength of the signals from the largest to the smallest for a wireless communication device which is one of a camera, a cellular phone, or a personal computer.

Because of this, the user can start the Wi-Fi Direct Connection communication between the desired wireless communication device and the printer 100 in a short period of time.

What is claimed is:

1. A wireless communication device that performs a wireless communication with other wireless communication devices comprising:
a communication unit that performs a peer-to-peer wireless communication with the other wireless communication devices; and
a communication control unit that controls the peer-to-peer wireless communication of the communication unit in accordance with a communication setting information;
wherein when the communication unit sends a search signal and receives a response signal in response to the sent search signal from a plurality of the other wireless communication devices, the communication control unit makes a determination for an order of sending a connection request to the plurality of other wireless communication devices based on a strength of the response signals;
the communication unit sends a connection request signal to the other wireless communication devices in accordance with the determined order, and when a connection permission signal for the connection request signal is received, the communication control unit establishes a connection of the peer-to-peer wireless communication with the other wireless communication devices that sent the connection permission signal.

2. The wireless communication device according to claim 1, wherein among the other wireless communication devices that sent the response signals, the communication control unit sends the connection request signals in the order of a strength of the response signals from the largest to the smallest in a predetermined limited number of devices.

3. The wireless communication device according to claim 1, wherein among the other wireless communication devices that sent the response signals, the communication control unit sends the connection request signals in the order of the strength of the response signals from the largest to the smallest in a predetermined ratio of limited number of the other wireless communication devices.

4. The wireless communication device according to claim 1, wherein the response signals include a device identification information of the other wireless communication devices, and among the other wireless communication devices that sent the response signals, the communication control unit sends the connection request signal to a wireless communication device having a predetermined device identification information.

5. The wireless communication device according to claim 4, further comprising: a print unit that prints an image data, wherein the wireless communication device having the predetermined device identification information sends the image data to the print unit.

6. The wireless communication device according to claim 1, wherein the communication setting information includes a temporary network identifier and the communication control unit produces the network identifier before sending the connection request signal.

7. The wireless communication device according to claim 1, wherein when a connection permission signal is received from the other wireless communication devices, the communication control unit stops sending the connection request signal and controls the peer-to-peer wireless communication with the other wireless communication devices that sent the connection permission signal.

8. The wireless communication device according to claim 1, wherein after receiving the connection refusal signal in response to the connection permission signal sent to one side of the other wireless communication devices, the communication control unit sends a connection request signal to the other side of the other wireless communication devices.
